(19) United States
(12) Patent Application Publication
(10) Pub. No.: US 2026/0058070 A1
(43) Pub. Date: Feb. 26, 2026

(54) ELECTRIC CURRENT SWITCH

(71) Applicant: ABB SCHWEIZ AG, Baden (CH)

(72) Inventor: Gunnar Johansson, Vasteras (SE)

(21) Appl. No.: 19/307,391

(22) Filed: Aug. 22, 2025

(30) Foreign Application Priority Data
Aug. 23, 2024 (EP) 24196217.4

(51) Int. Cl. H01H 1/36

(52) U.S. Cl. CPC H01H 1/36

(57) ABSTRACT

An electric current switch includes first and second fixed electrical contacts electrically connected; a movable single side electrical contact configured to make single side connection to and disconnect from the first fixed electrical contact for making and breaking electrical current in the electric current switch; and a movable second electrical contact configured to move in contact with the second fixed electrical contact subsequent to the making of current and to disconnect from the second fixed electrical contact before the breaking of electric current. An electrical connection between the movable second electrical contact and the second fixed electrical contact is by a double side contact connecting in a slot.

### FIELD OF THE INVENTION

The present invention relates to an electric current switch.

### BACKGROUND

Electric switches for medium- and high voltage switchgear are subject to large electrical currents. At a short circuit incident and before a short circuit protection device has cleared the fault, a very high current in contacts of the electric switch may cause contact separation between contacts that can severely damage the switch and the surrounding equipment.

Short circuit coordination between contacts and short circuit protection devices is challenging, especially for large switches that also require very large circuit breakers. Furthermore, since large switches often are slow in operation the time when the contacts is exposed to the short circuit current may become too long and cause excessively high release of energy that may damage the switch.

### SUMMARY

In view of the above-mentioned and other drawbacks of the prior art, it is an object of the present invention to provide an electric current switch that at least partly alleviates the deficiencies with prior art.

According to a first aspect of the invention, there is provided an electric current switch comprising: a first fixed electrical contact; a second fixed electrical contact electrically connected with the first fixed electrical contact; a movable single side electrical contact configured to make single side connection and to disconnect from the first fixed electrical contact for making and breaking electrical current in the electric current switch; a movable second electrical contact configured to move in contact with the second fixed electrical contact subsequent to the making of current and to disconnect from the second fixed electrical contact before the breaking of electric current; wherein an electrical connection between the movable second electrical contact and the second fixed electrical contact is by a double side contact connecting in a slot, where one of the movable second electrical contact and the second fixed electrical contact comprises one of the double side contact and the slot and the other one of the movable second electrical contact and the second fixed electrical contact comprises the other one of the double side contact and the slot.

The present invention is at least partly based on the realization to have parallel contacts where normal operations are handled by a first system with single side contacts separate from a second system with double side contacts that keeps the circuit closed in case of short circuit. The first system performs the normal operations whereas the second system handle short circuit situations and is especially adapted for conducting high electrical current.

The slot also forms a double side contact. Thus, in the second system, it may be considered that two double side contacts mate.

Since the double sided contacts does not have to conduct current during normal operations the contact force in the second system, that is, between the double sided contacts, can be relatively low, or at least lower than the contact force between the first fixed electrical contact and the movable single side electrical contact during normal operations. This reduces wear on the double sided contacts and simplifies its actuator mechanism.

A single sided contact is a contact that contacts the fixed electrical contact on one side only. That is, a single side surface of the contact makes and breaks electrical contact with the first fixed electrical contact. Single sided thus refers to the side where electrical connection is made.

The single sided contact comprises a single surface adapted to contact a corresponding surface of the fixed electrical contact for conducting electrical current between the single sided contact and the fixed electrical contact.

The double-sided contact comprises two separate surfaces that make contact with corresponding surfaces of the mating contact. The double-sided contact may comprise two parallel surfaces, either facing each other, or facing in opposite directions.

In other words, one of the double-sided contact and the corresponding mating contact has contact points facing outwards and the other one has contact points facing inwards, where the one having the inwards facing contact points comprises two parallel paths or branches for the electric current.

In case of a short circuit, the double-sided contact get trapped in the slot, either due to rigid mating contact members, or due to forces created as the high currents pass through the parallel branches of the slot.

In a closed position of the electric switch, an electric current may pass between the fixed contacts and their respective mating contact. In an open position, the fixed contacts and their respective mating contact are not in contact whereby an electric current may not pass between them.

In embodiments, the electrical connection between the double side contact and the slot may be made at sides inside the slot that face each other. The double side contact engaging with both facing sides inside the slot ensures a more stable and secure electrical connection. This configuration reduces the likelihood of contact separation during short circuit.

In embodiments, the movable second electrical contact and the second fixed electrical contact may be configured such that an electrical connection between them is configured to maintain in the event of a short circuit fault that cause the movable single side electrical contact to separate from the first fixed electrical contact. In other words, the movable second electrical contact is configured to be trapped in the second fixed electrical contact in case of a short circuit such that the electrical switch and surrounding equipment can be protected. That is, abrupt separation of the movable second electrical contact and the second fixed electrical contact is prevented in the event of a short circuit to allow for a short circuit protection device to clear the fault.

In embodiments, the single side movable electrical contact may be configured for switching and conducting and the second movable electrical contact may be configured for conducting. It is preferred that the single side movable electrical contact handle normal operation and that the second movable electrical contact handle conducting in the event of short circuit.

In embodiments, the electric current switch may further comprise an actuator mechanism configured to synchronize the movement of the movable single side electrical contact and the movable second electrical contact. The actuator mechanism improves the timing between the movable single side electrical contact and the movable second electrical contact during switching operations, thereby improving reliability of the electrical switch.

In embodiments, the electric current switch may comprise a separate arcing contact configured to close the electrical connection prior to the movable single side electrical contact. Preferably, the double sided contact should close simultaneously with the movable single side electrical contact or slightly after it, the double sided contact should open slightly before or simultaneously with the movable single side electrical contact. The single side electrical contact is herein considered the main contact that is configured to handle the making and breaking current as well as conducting electrical current in normal operations. The double sided contact is configured to handle the high currents during short circuit.

In embodiments, the movable second electrical contact may comprise the slot and the second fixed electrical contact comprises a double side contact. The is, the slot is on the movable second electrical contact that move to make connection with the fixed double side contact. The slot may be formed as a result of the motion of the movable second electrical contact.

In embodiments, the movable second electrical contact may comprise a single slot and the movable second electrical contact is movable by an angular motion.

In embodiments, the movable second electrical contact may comprise two slots, one on each end of the movable second electrical contact, each of the two slots are configured to connect with a receptive fixed double side contact of the second fixed electrical contact.

The movable second electrical contact may comprise two parallel conductors that are attracted to each other by forces created by electric currents in the two parallel conductors. The force is known as the Lorentz force generated by conduction of electric current. Since currents passing through the two parallel conductors are parallel and have the same direction, attracting forces will be created between the two halves of the movable second electrical contact. These attracting forces will further increase the contact force in the electrical contact points, wherein the attracting forces can be greater than the separation forces created in the contact points.

In embodiments, the motion of the movable second electrical contact is a linear motion. In case of two parallel conductors, the parallel conductors may move linearly towards each other for forming the slots and making contact with the double side contact.

In embodiments, the movable second electrical contact may comprise double side contact and the second fixed electrical contact comprises the slot.

In embodiments, the electrical connection between the first fixed electrical contact and the single sided movable electrical contact may be in parallel with the electrical connection between the second fixed electrical contact and the second movable electrical contact. That is, when the first fixed electrical contact and the single sided movable electrical contact separate, the electric current may still flow between the second fixed electrical contact and the second movable electrical contact.

In embodiments, the movable first electrical contact and the movable second electrical contact may be operated by actuator systems that allow independent operation.

In embodiments, the movable single side electrical contact and the first fixed contact has a single position of rest, operated otherwise than by hand, capable of making, carrying and breaking currents under normal circuit conditions including operating overload conditions. That is, the movable single side electrical contact and the first fixed contact is a contactor according to IEC product standard IEC60947-4-1.

Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

These and other aspects of the present invention will now be described in more detail, with reference to the appended drawings showing an example embodiment of the invention, wherein:

FIG. 1 illustrates an example electric current switch according to embodiments of the invention;

FIG. 2 illustrates the sequential motion of the movable the single side contact and the movable second electrical contact according to embodiments of the invention;

FIG. 3A illustrates an example movable second electrical contact and second fixed contact in an open position according to embodiments of the invention;

FIG. 3B illustrates an example movable second electrical contact and second fixed contact in a closed position according to embodiments of the invention;

FIG. 4A illustrates an example movable second electrical contact and second fixed contact in an open position according to embodiments of the invention;

FIG. 4B illustrates an example movable second electrical contact and second fixed contact in a closed position according to embodiments of the invention; and

FIG. 5 illustrates an example movable second electrical contact and second fixed contact in a closed position according to embodiments of the invention.

### DETAILED DESCRIPTION OF EXAMPLE EMBODIMENTS

In the present detailed description, various embodiments of the present invention are herein described with reference to specific implementations. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the scope of the invention.

Electric contact in a contactor is achieved by bringing two or more contact members together, often termed it “makes the current”. When contacts are kept together and a current flows, it conducts the current. When contacts are separated, it breaks the current. These are the three basic functions of a contactor, make, conduct, and break. During make and break, electric arcs are often created, and these arcs must be handled by the contacts and other parts of the system. When conducting, the contacts shall have a good conductivity thus minimizing the power losses. The contacts in a contactor therefore need to be both resistant to arcing and have a good conductivity, but these two requirements are often in conflict. A consequence is that the chosen contact materials are compromises between the different requirements but not optimal for any of them, in addition lots of contact material is needed as it erodes during the make and break operations. The contact material is normally a silver-based alloy or composite; thus, it represents a high cost.

A way to avoid the material compromise is to split the contacts in two or more parallel branches, having separate branches for switching (make and break), and having other separate branches for conducting. This allows to have different contact materials for switching and for conducting, such as using a high arcing resistive material in the switching branch and using a well conductive material in the conducting branch.

The resistance in an electric contact depends on the contact force between the contact members. The so-called constriction resistance, R, for two equal contact members with resistivity “ρ” and hardness “Hᵥ” that are kept together with a contact force “F_{c}”, is defined by the relation:

$$R \sim ρ \sqrt{\frac{{H}_{v}}{{F}_{c}}}$$

Thus, it is beneficial to ensure a high contact force F_{c}.

Antiparallel currents create a Lorenz force “F” that will try to separate the two contact members, this force is proportional to the square of the current, i:

$${F}_{I} ∼ {i}^{2}$$

The Lorenz force must be compensated by the contact force, F_{c}. This may be acceptable for normal levels of current. But, when the contacts are exposed for extremely high current, as for instance during a short circuit, it becomes very difficult to keep the contact members together. If contacts separate with high current, a high power will be released that can damage both the contactor and other nearby equipment. This issue is addressed by the herein described embodiments.

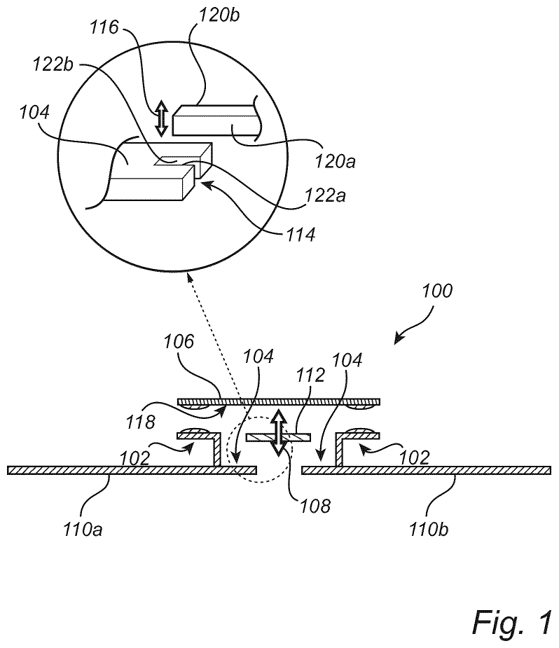

FIG. 1 conceptually illustrates an electric current switch 100 according to embodiments of the present invention.

The electric current switch 100 comprises a first fixed electrical contact 102 and a second fixed electrical contact 104 electrically connected with the first fixed electrical contact 102.

A movable single side electrical contact 106 is configured to make single side connection with the first fixed electrical contact 102 and to disconnect from the first fixed electrical contact 102 for making and breaking electrical current in the electric current switch 100. In other words, the movable single side electrical contact 106 can move along axis 108 towards the first fixed electrical contact 102 and until in contact is made between the movable single side electrical contact 106 and the first fixed electrical contact 102. In FIG. 1, the electric switch 100 is in its open position where electric current cannot flow through the electric current switch 100 from one side 110a to the other side 110b of the electric current switch 100, or stated otherwise, between the poles of the electric current switch 100. Once connection is made between the movable single side electrical contact 106 and the first fixed electrical contact 102, an electric current can flow between the sides 110a-b, or equally between the poles of the electric current switch 100.

Furthermore, a movable second electrical contact 112 is configured to move in contact with the second fixed electrical contact 104 subsequent to the making of current and to disconnect from the second fixed electrical contact 104 before the breaking of electric current. The movements of the movable single side electrical contact 106 and second electrical contact 112 are sequential such that the movable single side electrical contact 106 makes contact prior to that the movable second electrical contact 112 move in contact with the second fixed electrical contact 104. Furthermore, for breaking current the sequential movements are such that the movable second electrical contact 112 breaks its contact with the second fixed electrical contact 104 prior to the breaking of current by the movable single side electrical contact 106.

The electrical connection between the movable second electrical contact 112 and the second fixed electrical contact 104 is by a double side contact connecting in a slot 114, forming a further double-sided contact. One of the movable second electrical contact and the second fixed electrical contact comprises one of the double side contact and the slot and the other one of the movable second electrical contact and the second fixed electrical contact comprises the other one of the double side contact and the slot. In this example embodiment, the movable second electrical contact 112 is a double-sided electrical contact 112 and the slot 114 is comprised in the second fixed electrical contact 104.

The double side contact 112 moves linearly 116 for making or breaking its connection in the slot 114 of the second fixed electrical contact 104. There is a slot 114 in each of the second fixed electrical contact 104.

The single side contact 106 has a single side 118 where contact is made with the first fixed electrical contact 102. When the single side contact 106 moves linearly to the first fixed electrical contact 102, the single side 118 comes in contact with the first fixed electrical contact 102 such that electrical current can flow between the poles 110a and 110b.

The double side contact 112 has two sides 120a and 120b which face in opposite directions but are otherwise parallel. The two sides 120a and 120b make contact with respective sides 122a and 122b in the slot 114 for making connection between the double side contact 112 and the slot 114. The sides 122a-b of the slot face each other.

Contact is made at the sides 120a-b of the double side contact 112 with the inner walls 122a-b of the slot 114. In case of short-circuit, the movable double side contact 112 is trapped in the slot 114, and separation forces (Lorentz forces) will only push double side contact 112 from one side 122a to the other side 122b. In this way, the movable second electrical contact 112 and the second fixed electrical contact 104 are configured such that an electrical connection between them is configured to maintain in the event of a short circuit fault that cause the movable single side electrical contact 106 to separate from the first fixed electrical contact 102.

The electrical connection between the first fixed electrical contact 102 and the single sided movable electrical contact 106 is in parallel with the electrical connection between the second fixed electrical contact 104 and the second movable electrical contact 112.

The electrical connection the first fixed electrical contact 102 and the single sided movable electrical contact 106 handle the normal operation of the electrical current switch 100. That is, the conduction of electric current during normal operation is mostly through by the first fixed electrical contact 102 and the single sided movable electrical contact 106. In case of a short circuit, the high electric currents are conducted by the electrical connection between the second fixed electrical contact 104 and the second movable electrical contact 112. This means that the contact force between the electrical connection between the second fixed electrical contact 104 and the second movable electrical contact 112 during normal operation can be lower than the contact force between first fixed electrical contact 102 and the single sided movable electrical contact 106. During normal operation, the majority of the electric current is conducted by the first fixed electrical contact 102 and the single sided movable electrical contact 106 whereas during a short circuit the electric current is conducted by the double-sided contacts 104 and 112.

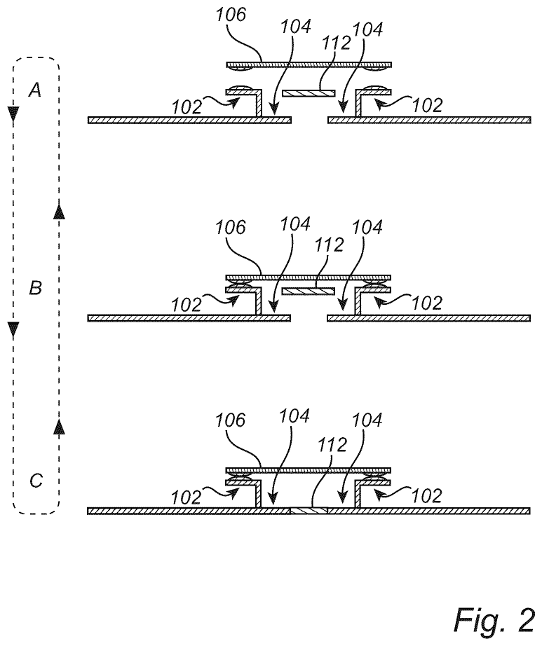

FIG. 2 illustrates the sequential motion of the movable the single side contact 106 and the movable second electrical contact 112.

At “A” the circuit is open. At making “B” the single side contact 106 closes, current starts to flow and some arcing may occur and a good conductivity is established. At continuous conducting “C” also the movable second electrical contact 112 closes and the conductivity is relatively high and no arcing occurs since good conductivity is already established by the single side contact 106 and the first fixed contact 102. At break, the movable second electrical contact 112 will move out from the slot 114, no arcing will occur since good conductivity is kept by the single side contact 106 and the first fixed contact 102. Thereafter the moving single side contact 106 will open and break the current. The sequence at closing is A-B-C, the opposite sequence is used at opening C-B-A.

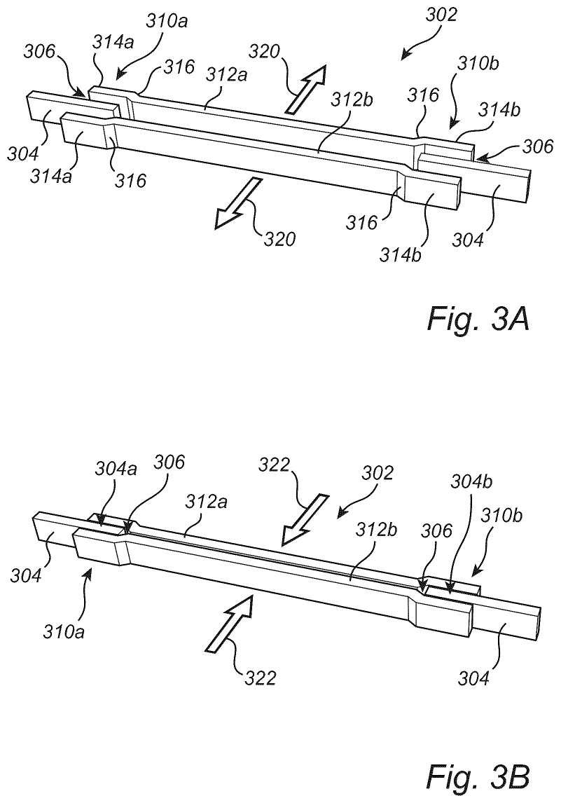

FIG. 3A illustrates an example movable second electrical contact 302 and a second fixed electrical contact 304 in an open position according to an embodiment. Here, the movable second electrical contact 302 comprises the slot 306 and the second fixed electrical contact is a double side contact 304.

In this embodiment, the movable second electrical contact 302 comprises two slots 306, one on each end 310a-b of the movable second electrical contact 302. Each of the two slots 306 are configured to connect with a receptive fixed double side contact 304a-b of the second fixed electrical contact 304.

The movable second electrical contact 302 comprises two parallel conductors 312a and 312b. The end portions 314a-b of the parallel conductors 312a and 312b comprises a bent portion 316 which cause the slots 306 to be formed between the end portions 314a and the end portions 314b.

The open the movable second electrical contact 302 and a second fixed electrical contact 304 the two parallel conductors 312a-b are linearly moved away from each other in opposite directions as indicated by arrows 320. The motion may be realized many different ways such as using springs or other actuators that can move the two parallel conductors 312a-b.

FIG. 3B illustrates an example movable second electrical contact 302 and a second fixed electrical contact 304 in a closed position. For closing the movable second electrical contact 302 and the second fixed electrical contact 304 the two parallel conductors 312a-b are linearly moved towards each other in as indicated by arrows 322. During normal operation, there is no need for conducting current between the movable second electrical contact 302 and the second fixed electrical contact 304 since the conduction is handled by the first fixed electrical contact and the single sided electrical contact. Therefore, the contact force between the movable second electrical contact 302 and the second fixed electrical contact 304 is less than the contact force between the movable single side electrical contact and the first fixed electrical contact during normal operation. During s short circuit, typically causing separation between the movable single side electrical contact and the first fixed electrical contact a high current flows in the two parallel conductors 312a-b and the two parallel conductors 312a-b are attracted to each other by a force created by the electric current in the two parallel conductors 312a, and 312b. This force is the Lorentz force that is generated during conduction of electric current. The attracting forces will further increase the contact force in the contact points between the two parallel conductors 312a-b. The attracting forces can be greater than the separation forces created in the contact points in the event of a short circuit.

The fixed double side contacts 304a-b may be provided in the form of knife contacts or blade contacts.

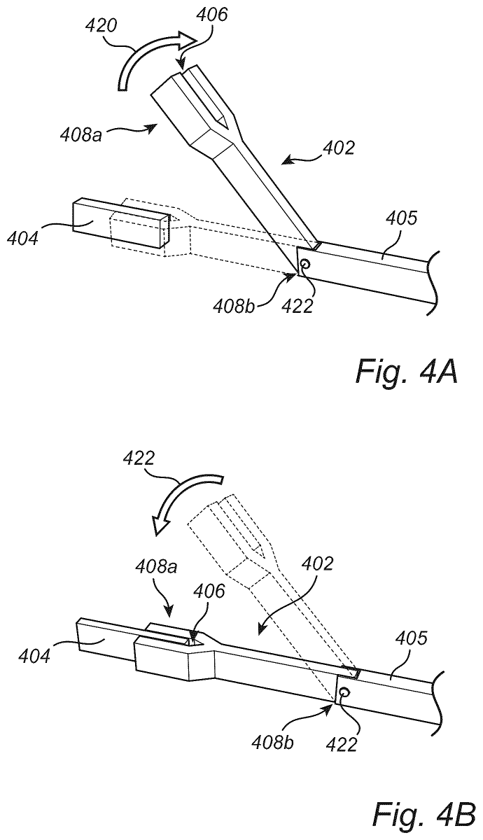

FIG. 4A illustrates an example movable second electrical contact 402 and a second fixed electrical contact 404 in an open position according to an embodiment. Here, the movable second electrical contact 402 comprises the slot 406 and the second fixed electrical contact is a double side contact 404, such as a knife or blade contact.

In this embodiment, the movable second electrical contact 402 comprises one single slot 406 on one end 408a of the second electrical contact 402. The other end 408b is rotationally connected to a fixed second fixed electrical contact 404.

The open the connection between the movable second electrical contact 402 and the second fixed electrical contact 404 the movable second electrical contact 402 is rotated to cause an angular motion indicated by arrow 420.

FIG. 4B illustrates the example movable second electrical contact 402 and a second fixed electrical contact 404 in a closed position according to an embodiment. Here, the movable second electrical contact 402 is rotated about its pivot point 422 such that the slot 406 surrounds and is on contact with the second fixed electrical contact 404. In this closed position electric current can flow between the movable second electrical contact 402 and the second fixed electrical contact 404. The movable second electrical contact 402 is connected to conductor 405 at its end 408b.

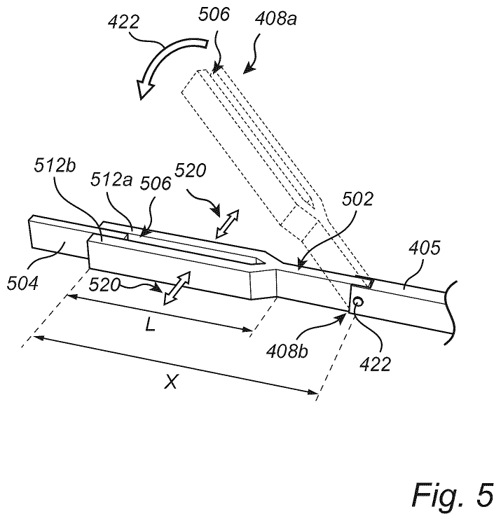

FIG. 5 illustrates an example movable second electrical contact 502 and a second fixed electrical contact 504 in a closed position according to an embodiment. The movable second electrical contact 502 is rotated about its pivot point 422 at end 408b, such that the slot 506, at end 408a of movable second electrical contact 502, surrounds and is on contact with the second fixed electrical contact 504. In this closed position electric current can flow between the movable second electrical contact 502 and the second fixed electrical contact 504. The length L of the two parallel conductors 512a,b are more than half the total length X of the movable second electrical contact 502, such as about or more than 60%, or about or more than 75%, or about or more than 90% of the total length X. With longer parallel conductors 512a,b their ability to flex, indicated by arrows 520, especially inwards due to the attracting forces caused by the parallel currents is improved which increases the contact force during short circuit.

In some embodiments the electric current switch may comprise a separate arcing contact configured to close the electrical connection prior to the first movable electrical contact. In such case, a third connection step is included prior to the making of current using the movable single side electrical contact.

The movable single side electrical contact and the first fixed contact has a single position of rest, operated otherwise than by hand, capable of making, carrying and breaking currents under normal circuit conditions including operating overload conditions. The movable single side electrical contact and the first fixed contact may be an arrangement defined as a contactor in IEC product standard IEC60947-4-1.

The motion of the movable single side electrical contact and the movable second electrical contact may be controlled in different ways to allow for synchronized motion. In one possible implementation they are operated by separate actuator systems that to allow independent operation. In other possible implementations, the electric current switch may comprise an actuator mechanism configured to synchronize the movement of the movable single side electrical contact and the movable second electrical contact.

Even though the invention has been described with reference to specific exemplifying embodiments thereof, many different alterations, modifications and the like will become apparent for those skilled in the art.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. An electric current switch comprising:
a first fixed electrical contact;
a second fixed electrical contact electrically connected with the first fixed electrical contact;
a movable single side electrical contact configured to make single side connection to and disconnect from the first fixed electrical contact for making and breaking electrical current in the electric current switch; and
a movable second electrical contact configured to move in contact with the second fixed electrical contact subsequent to the making of current and to disconnect from the second fixed electrical contact before the breaking of electric current;
wherein an electrical connection between the movable second electrical contact and the second fixed electrical contact is by a double side contact connecting in a slot, where one of the movable second electrical contact and the second fixed electrical contact comprises one of the double side contact and the slot and the other one of the movable second electrical contact and the second fixed electrical contact comprises the other one of the double side contact and the slot.

2. The electric current switch according to claim 1, wherein the electrical connection between the double side contact and the slot is made at sides inside the slot that face each other.

3. The electric current switch according to claim 1, wherein the movable second electrical contact and the second fixed electrical contact are configured such that an electrical connection between them is configured to maintain in the event of a short circuit fault that cause the movable single side electrical contact to separate from the first fixed electrical contact.

4. The electric current switch according to claim 1, wherein the single side movable electrical contact is configured for switching and conducting and the second movable electrical contact is configured for conducting.

5. The electric current switch according to claim 1, further comprising an actuator mechanism configured to synchronize the movement of the movable single side electrical contact and the movable second electrical contact.

6. The electric current switch according to claim 1, comprising a separate arcing contact configured to close the electrical connection prior to the first movable electrical contact.

7. The electric current switch according to claim 1, wherein the movable second electrical contact comprises the slot and the second fixed electrical contact comprises a double side contact.

8. The electric current switch according to claim 7, the movable second electrical contact comprises a single slot and the second electrical contact is movable by an angular motion.

9. The electric current switch according to claim 7, wherein the movable second electrical contact comprises two slots, one on each end of the movable second electrical contact, each of the two slots are configured to connect with a receptive fixed double side contact of the second fixed electrical contact.

10. The electric current switch according to claim 9, wherein the movable second electrical contact comprises two parallel conductors that are attracted to each other by forces created by electric currents in the two parallel conductors.

11. The electric current switch according to claim 7, wherein the motion of the movable second electrical contact is a linear motion.

12. The electric current switch according to claim 1, wherein the movable second electrical contact comprises double side contact and the second fixed electrical contact comprises the slot.

13. The electric current switch according to claim 1, wherein the electrical connection between the first fixed electrical contact and the single sided movable electrical contact is in parallel with the electrical connection between the second fixed electrical contact and the second movable electrical contact.

14. The electric current switch according to claim 1, wherein the movable first electrical contact and the movable second electrical contact are operated by separate actuator systems to allow independent operation.

15. The electric current switch according to claim 1, wherein the movable single side electrical contact and the first fixed contact has a single position of rest, operated otherwise than by hand, capable of making, carrying and breaking currents under normal circuit conditions including operating overload conditions.

16. The electric current switch according to claim 2, wherein the movable second electrical contact and the second fixed electrical contact are configured such that an electrical connection between them is configured to maintain in the event of a short circuit fault that cause the movable single side electrical contact to separate from the first fixed electrical contact.

17. The electric current switch according to claim 3, wherein the single side movable electrical contact is configured for switching and conducting and the second movable electrical contact is configured for conducting.

18. The electric current switch according to claim 6, wherein the movable second electrical contact comprises the slot and the second fixed electrical contact comprises a double side contact.

19. The electric current switch according to claim 8, wherein the movable second electrical contact comprises two slots, one on each end of the movable second electrical contact, each of the two slots are configured to connect with a receptive fixed double side contact of the second fixed electrical contact.

20. The electric current switch according to claim 10, wherein the motion of the movable second electrical contact is a linear motion.
